(19) United States
(12) Patent Application Publication
(10) Pub. No.: US 2003/0202712 A1
(43) Pub. Date: Oct. 30, 2003

(54) Data compression

(76) Inventors: Robert Mark Stefan Porter, Winchester (GB); James Edward Burns, Basingstoke (GB); Nicholas Ian Saunders, Basingstoke (GB)

Correspondence Address: FROMMER LAWRENCE & HAUG LLP, 745 FIFTH AVENUE, NEW YORK, NY, 10151, US

(21) Appl. No.: 10/400,103

(22) Filed: Mar. 26, 2003

(30) Foreign Application Priority Data
Mar. 28, 2002 (GB) 0207424.3

(51) Int. Cl. G06K 9/36

(52) U.S. Cl. 382/251

(57) ABSTRACT

A data compression apparatus operable to perform at least one trial quantisation in order to compress input data in accordance with a predetermined target output data quantity comprises a quantisation starting point estimator for detecting, from a property of the input data, a quantisation starting point representing an approximate value for a quantisation parameter suitable for achieving the predetermined target output data quantity; one or more trial quantisers, each testing a degree of quantisation of at least part of the input data, the degree of quantisation being defined by a respective trial quantisation parameter; a parameter controller for assigning a value of the trial quantisation parameter to each of the trial quantisers in dependence upon the quantisation starting point; and a parameter selector for selecting a final level of quantisation for use in compression of the input data in accordance with results of the testing performed by the one or more trial quantisers, to ensure that the target output data quantity is not exceeded.

### BACKGROUND OF THE INVENTION

1. Field of the Invention

The present invention relates to data compression.

2. Description of the Prior Art

Data compression techniques are used extensively in the data communications field in order to communicate data at bit rates that can be supported by communication channels having dynamically changing but limited bandwidths. Image data is typically compressed prior to either transmission or storage on an appropriate storage medium and it is decompressed prior to image reproduction.

In the case of still images data compression techniques take advantage of spatial redundancy, whilst for moving images both spatial and temporal redundancy is exploited. Temporal redundancy arises in moving images where successive images in a temporal sequence, particularly images belonging to the same scene, can be very similar. The Motion Picture Experts Group (MPEG) has defined international standards for video compression encoding for entertainment and broadcast applications. The present invention is relevant to (though not at all restricted to) implementations of the MPEG4 “Studio Profile” standard that is directed to high end video hardware operating at very high data rates (up to 1 Gbit/s) using low compression ratios.

Discrete Cosine Transform (DCT) Quantisation is a widely used encoding technique for video data. It is used in image compression to reduce the length of the data words required to represent input image data prior to transmission or storage of that data. In the DCT quantisation process the image is segmented into regularly sized blocks of pixel values and typically each block comprises 8 horizontal pixels by 8 vertical pixels (8_{H}×8_{V}). In conventional data formats video data typically has three components that correspond to either the red, green and blue (RGB) components of a colour image or to a luminance component Y along with two colour difference components Cb and Cr. A group of pixel blocks corresponding to all three RGB or YCbCr signal components is known as a macroblock (MB).

The DCT represents a transformation of an image from a spatial domain to a spatial frequency domain and effectively converts a block of pixel values into a block of transform coefficients of the same dimensions. The DCT coefficients represent spatial frequency components of the image block. Each coefficient can be thought of a weight to be applied to an appropriate basis function and a weighted sum of basis functions provides a complete representation of the input image. Each 8_{H}×8_{V} block of DCT coefficients has a single “DC” coefficient representing zero spatial frequency and 63 “AC” coefficients. The DCT coefficients of largest magnitude are typically those corresponding to the low spatial frequencies. Performing a DCT on an image does not necessarily result in compression but simply transforms the image data from the spatial domain to the spatial frequency domain. In order to achieve compression each DCT coefficient is divided by a positive integer known as the quantisation divisor and the quotient is rounded up or down to the nearest integer. Larger quantisation divisors result in higher compression of data at the expense of harsher quantisation. Harsher quantisation results in greater degradation in the quality of the reproduced image. Quantisation artefacts arise in the reproduced images as a consequence of the rounding up or down of the DCT coefficients. During compressed image reproduction each DCT coefficient is reconstructed by multiplying the quantised coefficient (rounded to the nearest integer), rather than the original quotient, by the quantisation step which means that the original precision of the DCT coefficient is not restored. Thus quantisation is a “lossy” encoding technique.

Image data compression systems typically use a series of trial compressions to determine the most appropriate quantisation divisor to achieve a predetermined output bit rate. Trial quantisations are carried out at, say, twenty possible quantisation divisors spread across the full available range of possible quantisation divisors. The two trial adjacent trial quantisation divisors that give projected output bit rates just above and just below the target bit rate are identified and a refined search is carried out between these two values. Typically the quantisation divisor selected for performing the image compression will be the one that gives the least harsh quantisation yet allows the target bit rate to be achieved.

Although selecting the least harsh quantisation will result in the best possible image quality (i.e. the least noisy image) on reproduction for “source” image data that has not undergone one or more previous compression/decompression cycles, it has been established that this is not necessarily the case for “non-source” image data. An image that has been compressed and decompressed once is referred to as a 1^{st} generation image, an image that has been subject to two previous compression/decompression cycles is known as a 2^{nd} generation and so on for higher generations.

Typically the noise in the image will be systematically higher across the full range of quantisation divisors for the 2nd generation reproduced image in comparison to the noise at a corresponding quantisation divisor for the 1^{st} generation reproduced image. This can be understood in terms of the DCT coefficient rounding errors incurred at each stage of quantisation. However, it is known that when the 2nd generation quantisation divisor is chosen to substantially equal to that used in the 1^{st} generation compression, the noise levels in the 2^{nd} generation reproduced image will be substantially equal to the noise levels in the 1st generation reproduced image. Thus for non-source input image data the quantisation divisor having the smallest possible magnitude that meets a required data rate will not necessarily give the best reproduced image quality. Instead, a quantisation divisor substantially equal to that used in a previous compression/decompression cycle is likely to give the best possible reproduced image quality. Note however that the choice of quantisation divisor is constrained by the target bit rate associated with the particular communication channel which may vary from generation to generation.

A problem with known systems for establishing the best quantisation step for image compression is that a large amount of processing circuitry is required to perform the trial quantisations across a full range of possible quantisation divisors. This is a particular problem where the circuitry is to be implemented in an Application Specific Integrated Circuit (ASIC). Furthermore the quantisation step used in the compression process of a previous data compression is unlikely to be a known parameter.

### SUMMARY OF THE INVENTION

This invention provides a data compression apparatus operable to perform at least one trial quantisation in order to compress input data in accordance with a predetermined target output data quantity, the apparatus comprising:

a quantisation starting point estimator for detecting, from a property of the input data, a quantisation starting point representing an approximate value for a quantisation parameter suitable for achieving the predetermined target output data quantity;

one or more trial quantisers, each testing a degree of quantisation of at least part of the input data, the degree of quantisation being defined by a respective trial quantisation parameter;

a parameter controller for assigning a value of the trial quantisation parameter to each of the trial quantisers in dependence upon the quantisation starting point; and a parameter selector for selecting a final level of quantisation for use in compression of the input data in accordance with results of the testing performed by the one or more trial quantisers, to ensure that the target output data quantity is not exceeded.

The invention addresses the problems described above by deriving an estimated quantisation starting parameter from the input data itself. Trial quantisations are then performed based around the estimated starting point. This can reduce the need to perform trial quantisations across the full range of available quantisation parameters.

### BRIEF DESCRIPTION OF THE DRAWINGS

The above and other objects, features and advantages of the invention will be apparent from the following detailed description of illustrative embodiments which is to be read in connection with the accompanying drawings, in which:

FIG. 1 is a schematic diagram of a compression encoder and a corresponding decoder for use with a data recording/reproducing device or a data transmission/reception system;

FIG. 2 schematically illustrates the bit rate reducing encoder of FIG. 1;

FIG. 3 is a table of parameters used in the bit rate reduction process of the encoder of FIG. 2;

FIG. 4 illustrates an alternative bit rate reducing encoder to that of FIG. 2;

FIG. 5 schematically illustrates the decoder of FIG. 1;

FIG. 6 schematically illustrates a parameter estimation circuit according to an embodiment of the invention;

FIG. 7 schematically illustrates a portion of the Q start estimation module of FIG. 5.

FIG. 8 is an example graph illustrating calculation of the error in the Q start estimation value.

FIG. 9 is a flow chart showing how the final values of Q_START and DCT_PRECISION are selected by the parameter estimation circuit of FIG. 6.

FIG. 10 schematically illustrates an alternative embodiment of the parameter estimation circuit of FIG. 6.

FIG. 11A schematically illustrates the use of Q_START in the bit allocation module of FIG. 2.

FIG. 11B schematically illustrates the use of Q_START in the parallel bit allocation module of FIG. 3.

FIG. 12 schematically illustrates the use of Q_START to select a subset of fixed Q_SCALE_CODES during bit allocation.

### DESCRIPTION OF THE PREFERRED EMBODIMENTS

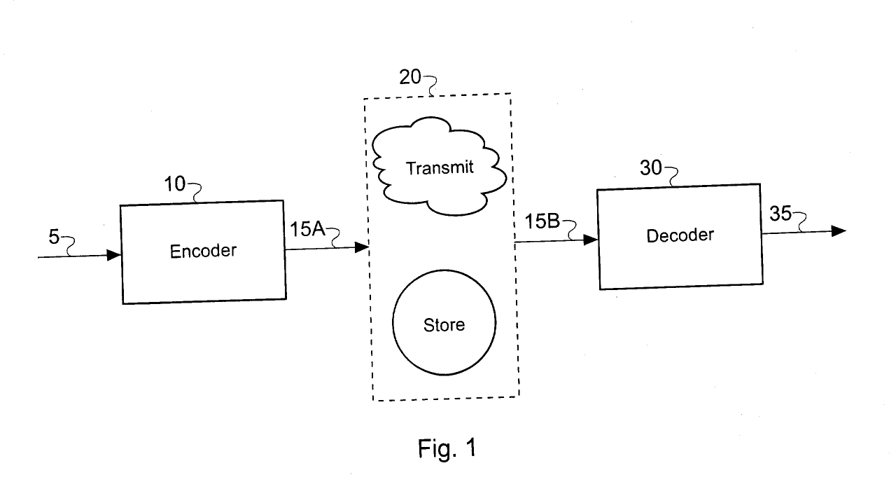

FIG. 1 is a schematic diagram of a data compression system. This system comprises an encoder 10, a data processing module 20 and a decoder 30. An input high definition video signal 5 is received by the encoder 10. The encoder 10 models the video image data to remove redundancy and to exploit its statistical properties. It produces output data symbols which represent the information in the input image data 5 in a compressed format. The encoder 10 outputs a compressed data signal 15A which is supplied as input to the data processing module 20 where it is either transmitted across a communication channel or stored on a recording medium. A compressed data signal 15B that was either read from the recording medium or received across a communication network is supplied to the decoder 30 that decodes the compressed data signal 15B to form a high definition image output signal 35.

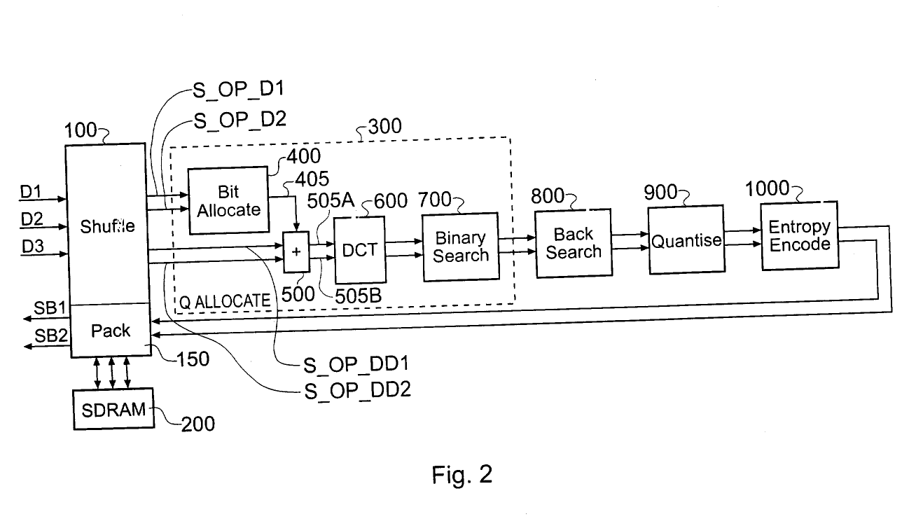

FIG. 2 schematically illustrates the bit rate reducing encoder of FIG. 1. Data signals D1, D2 and D3 correspond to RGB input channels for high definition video frames, which are supplied as input to a shuffle unit 100. It will be appreciated that in an alternative embodiment the data could be supplied in YC_{B}C_{R} format. The images can be processed either in a progressive frame mode or in an interlaced field mode. The shuffle unit serves to distribute the input data into Macro-Block Units (MBUs). In this embodiment there are 40 MBUs per video frame, each of which comprises 204 MBs. Image samples of each input frame are temporarily written to an external SDRAM 200. During this shuffle write process the values for two quantisation divisor parameters Q_START and DCT_PRECISION, which are required for the subsequent encoding process, are calculated. Blocks of pixels are read from the external SDRAM 200 according to a predetermined shuffle ordering that serves to interleave the image data so that blocks of pixels which are adjacent in the input image frame are not read out at adjacent positions in the shuffle ordering.

The shuffle process alleviates the effect of data losses on the image reconstructed by the decoder apparatus. Pixel blocks that are adjacent to each other in the input video frame are separated in the shuffled bit stream. A short duration data loss in which a contiguous portion of the bit stream is corrupted may affect a number of data blocks but due to the shuffling these blocks will not be contiguous blocks in the reconstructed image. Thus data concealment can feasibly be used to reconstruct the missing blocks. The shuffle process improves the picture quality during shuttle playback. It also serves to reduce the variation in the quantisation parameters selected for the MBUs in an image frame by distributing input video data pseudo-randomly in the MBUs.

A current image frame is written to the external SDRAM 200 while a previous frame is read, in shuffled format, from the external SDRAM 200. The shuffle unit 100 generates two output signal pairs: a first pair comprising signals S_OP_D1 and S_OP_D2 and a second pair comprising signals S_{OP}_DD1 and S_OP_DD2 which contain the same MBU data but delayed by approximately one MBU with respect to the data of the first signal pair. This delay serves to compensate for the processing delay of a bit allocation module 400 belonging to a Q allocation unit 300. The first signal pair S_OP_D1 and S_OP_D2 is used by the Q allocation unit 300 to determine an appropriate coding mode and a quantisation divisor known as a Q_SCALE parameter for each MB of the MBU.

The output signals from the shuffle unit 100 are supplied to the Q allocation unit 300 that comprises the bit allocation module 400, a target insertion module 500, a DCT module 600 and a binary search module 700. The first output signal pair S_OP_D1 and S_OP_D2 from the shuffle unit 100 are supplied as input to the bit allocation module 400. The input to the bit allocation module 400 comprises raster scanned 8_{H}×8_{V} vertical blocks of 12-bit video samples.

The bit allocation module 400 performs a comparison between lossless differential pulse code modulation (DPCM) encoding and DCT quantisation encoding.

DPCM is a simple image compression technique that takes advantage of the fact that spatially neighbouring pixels in an image tend to be highly correlated. In DPCM the pixel values themselves are not transmitted. Rather, a prediction of the probable pixel value is made by the encoder based on previously transmitted pixel values. A single DPCM encoding stage involves a DPCM reformat, a DPCM transform and entropy encoding calculations.

By way of contrast, the DCT quantisation encoding involves a single DCT transform plus several stages of quantisation using a series of quantisation divisors, each quantisation stage being followed by Huffman entropy encoding calculations. In this embodiment 4 trial quantisation divisors are tested by the bit allocation module 400. Huffman coding is a known lossless compression technique in which more frequently occurring values are represented by short codes and less frequent values with longer codes. The DCT trial encoding stages optionally involve quantisation that is dependent on the “activity” of an image area. Activity is a measure calculated from the appropriately normalised pixel variance of an image block. Since harsher quantisation is known to be less perceptible to a viewer in image blocks having high activity the quantisation step for each block can be suitably adjusted according to its activity level. Taking account of activity allows for greater compression while maintaining the perceived quality of the reproduced image.

The DPCM and DCT quantisation trial encoding stages are used to calculate MB bit targets constrained by a predetermined frame target calculated from the required encoding bit rate. For each MB the mode (DCT or DPCM) that gives the fewest encoded bits is selected. The bit allocation module outputs a signal 405 to the target insertion module 500. The signal 405 comprises information about the encoding mode selected for each Macro-Block, a Q_SCALE quantisation divisor Q_{BASE} to be used by a binary search module 700 and a bit target for each Macro-Block. The Q_{BASE} value, encoding mode information and the bit target for each Macro-Block in the signal 405 is added to the bit stream of the delayed image data to which it corresponds by the target insertion module 500. The target insertion module 500 outputs two signals 505A and 505B which are supplied as inputs to the DCT module 600.

The DCT module 600 again calculates DCT coefficients, this time based on the delayed version of the image data. The DCT module 600 outputs the data to the binary search module 700. The binary search module 700 performs a second stage of Q allocation for each of the DCT mode MBs and uses a binary search technique to determine an appropriate quantisation divisor for each Macro-Block. The binary search module 700 determines the quantisation divisor to a higher resolution (within a given range of available quantisation divisors) than the resolution used by the bit allocation module 400. In fact Q_{BASE} is used to define a starting point for a five stage binary search that results in the selection of a higher resolution quantisation step Q_{ALLOC} for each DCT mode Macro-Block. The DPCM mode Macro-Blocks are routed through the binary search module 700 via a bypass function so that the data is unaltered on output.

The output from the binary search module 700 that includes the value Q_{ALLOC} for each DCT mode Macro-Block is supplied to a back search module 800. The back search module 800 checks that the Q_{ALLOC} value chosen for each MB is the “best” quantisation scale for encoding. As explained in the introduction, for image data that has undergone at least on previous encode/decode cycle, the least harsh quantisation that is achievable for a given target bit count will not necessarily give the smallest possible quantisation error for the Macro-Block. Instead, the smallest quantisation error is likely to be achieved by using a quantisation divisor that is substantially equal to the quantisation divisor used in the previous encode/decode cycle. Accordingly, the back search module 800 estimates the quantisation error for a range of quantisation divisors starting at Q_{ALLOC} and working towards harsher quantisations. It determines the quantisation step Q_{FINAL} that actually produces the smallest possible quantisation error. The trial quantisations are performed on DCT mode Macro-Blocks only and a bypass function is provided for DPCM mode macroblocks.

The output from the back search module 800 which includes DCT blocks generated by the DCT encoder 600 together with the selected quantisation step Q_{FINAL} is supplied to a quantiser 900 where the final quantisation is performed. The quantisation procedure is as follows:

In DCT mode encoding the single DC coefficient of each 8_{H}×8_{V} block is quantised according to the equation:

Q(DC)=DC/(DC_{—}QUANT*DCT_SCALER)

where DC is the unquantised coefficient, DC_QUANT is a quantisation factor that is set by the system and is used to quantise all of the MBs. DC_QUANT is determined from DC_PRECISION as shown in the table below

| | | | | |
|---|---|---|---|---|
| DC_PRECISION | 00 | 01 | 10 | 11 |
| DC_QUANT | 8 | 4 | 2 | 1 |

DC_PRECISION is set to a fixed value, preferably 00, for each frame. DCT_SCALER is a quantisation factor determined by the DCT_PRECISION index such that DCT_SCALER=2^{DCT}^{_{—}}^{PRECISION}. In this embodiment a convention is used where DCT_PRECISION has the four possible values 0, 1, 2, 3 and 3 corresponds to the most harsh quantisation. Note that a different convention is used in the MPEG4 Studio Profile standard where DCT_PRECISION=0 corresponds to the most harsh quantisation whilst DCT_PRECISION=3 corresponds to the least harsh quantisation.

Similarly the 63 AC coefficients of the block are quantised according to the equation:

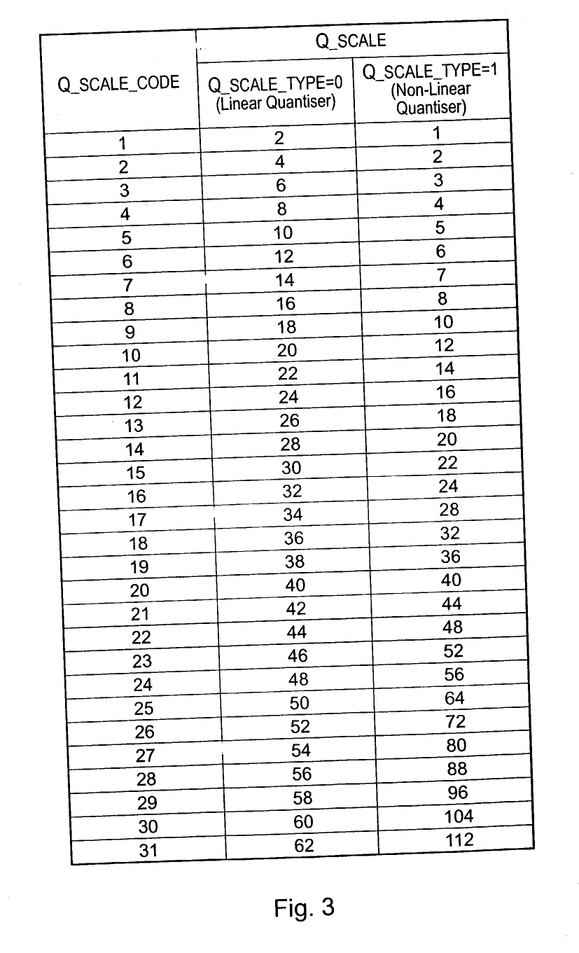

Q(AC)=(AC*16)/(Q_MATRIX*AC_{—}QUANTISE*DCT_SCALER)

where AC is the unquantised coefficient and Q_MATRIX is an array of 64 weights, one for each element of the DCT block. AC_QUANTISE is given by the product of Q_SCALE and NORM_ACT. Q_SCALE is a factor corresponding to either a linear quantiser scale or a non-linear quantiser scale, as specified by a Q_SCALE_TYPE. Each of the Q_SCALE_TYPEs comprises 31 possible values denoted Q_SCALE_CODE(1) to Q_SCALE_CODE(31). The table of FIG. 3 shows the Q_SCALE values associated with each Q_SCALE_TYPE for all 31 Q_SCALE_CODEs. In the above equation NORM_ACT is a normalised activity factor that lies the range 0.5 to 2.0 for “activity on” but is equal to unity for “activity off”. AC_QUANTISE=NORM_ACT*Q_SCALE is rounded up to the nearest Q_SCALE (i.e. a Q_SCALE that corresponds to one of the Q_SCALE_CODES in the Table of FIG. 3) before it is included as part of the divisor.

The results of the quantisations Q(DC) and Q(AC) are rounded using the known technique of normal infinity rounding. This technique involves rounding positive numbers less than 0.5 down (towards zero) and positive numbers greater than or equal to 0.5 up (towards plus infinity). Whereas negative numbers greater than −0.5 are rounded up (towards zero) and negative numbers less than or equal to −0.5 are rounded down (towards minus infinity).

The bit allocation module 400, the binary search module 700 and the back search module 800 each implement a quantisation process in accordance with that implemented by the quantise module 900 as detailed above. However in the binary search module 700 and the back search module 800 the factor NORM_ACT is always set equal to 1. Only during the bit allocation process carried out by the bit allocation module 400, does NORM_ACT take a value other than 1. Since the MB targets generated during bit allocation take account of activity, it need not be taken into account at subsequent stages.

The quantised data are output from the quantise module 900 and are subsequently supplied to an entropy encoder 1000 where lossless data compression is applied according to the standard principles of entropy encoding. In this embodiment Huffman encoding is used.

The output from the entropy encoder 1000 is supplied to a packing module 150 within the shuffle unit 100. The packing module 150 together with the external SDRAM 200 is used to pack the variable length encoded data generated by the entropy encode module 1000 into fixed length sync-blocks. A sync-block is the smallest data block that is separately recoverable during reproduction of the image.

The packing function is implemented by manipulation of the SDRAM read and write addresses. Each MBU is allocated a fixed packing space in the SDRAM which is then subdivided into a nominal packing space for each MB. The total length of each MB must also be stored and this can either be calculated from the individual word lengths or passed directly from the entropy encode module 1000 to the packing module 150. The output from the encoder 10 comprises sync-block 1 data output SB1 and sync-block 2 data output SB2. An indication of the quantisation divisors used in the encoding process is also transmitted to the decoder 30.

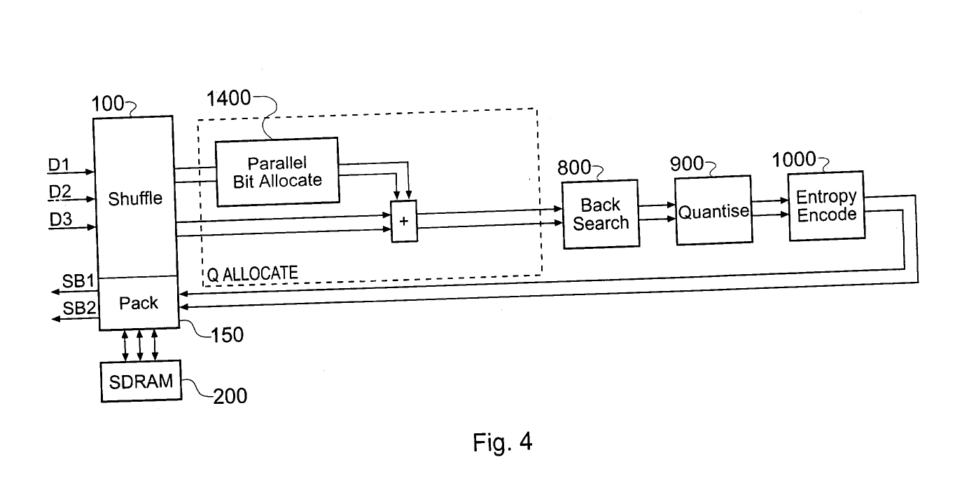

FIG. 4 illustrates an alternative form of encoder 10 to that shown in FIG. 2. The encoder of FIG. 4 is identical to that of FIG. 2 with the exception of the Q allocation unit 300. This alternative encoder does not have a binary search module but has a parallel bit allocation module 1400 capable of performing 24 parallel trial quantisations within the full range of 31 Q_SCALE_CODES. This offers a high enough resolution within the Q_SCALE range for direct calculation of the value Q_ALLOC. The bit allocation module 400 that was used in combination with the binary search module 700 in the encoder of FIG. 2 was capable of performing only 4 parallel trial quantisations at a coarse resolution. The appropriate Q_SCALE value was determined to a higher resolution by the binary search module in order to determine the value Q_ALLOC. The bit allocation module 400 comprises 4 quantiser unit/entropy encode unit pairs whereas the parallel bit allocation module 1400 comprises 24 quantiser unit/entropy encode unit pairs.

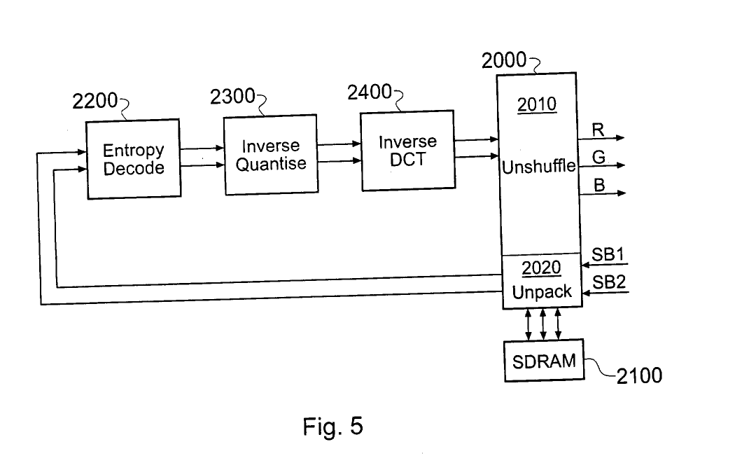

FIG. 5 schematically illustrates the decoder 30 of FIG. 1. The decoder is operable to reverse the encoding process and comprises an unshuffle unit 2010, an unpack unit 2020, an external SDRAM 2100, an entropy decoding module 2200, an inverse quantiser 2300 and an inverse DCT module 2400. The sync-block data signals SB1 and SB2 that are either read from the recording medium or received across a data transfer network are received by the unpack unit 2020 that implements an unpacking function by writing to and reading from the external SDRAM 2100. The unpacked data is supplied to the entropy decoder that reverses the Huffman coding to recover the quantised coefficients which are supplied to the inverse quantiser 2300. The inverse quantiser 2300 uses information supplied by the encoder 10 about the quantisation divisors and multiplies the quantised coefficients by the appropriate quantisation divisors to obtain an approximation to the original DCT coefficients. This inverse quantisation process does not restore the original precision of the coefficients so quantisation is a “lossy” compression technique. The output from the inverse quantiser 2300 is supplied to the inverse DCT module 2400 that processes each block of frequency domain DCT coefficients using an inverse discrete cosine transform to recover a representation of the image blocks in the spatial domain. The output of the inverse DCT module 2400 will not be identical to the pre-encoded pixel block due to the information lost as a result of the quantisation process. Finally the output of the inverse DCT module 2400 is supplied to the unshuffle unit 2010 where the data is unshuffled to recover the image block ordering of the pre-encoded image. The output of the unshuffle unit 2010 comprises the three colour component video signals RGB from which the image can be reconstructed.

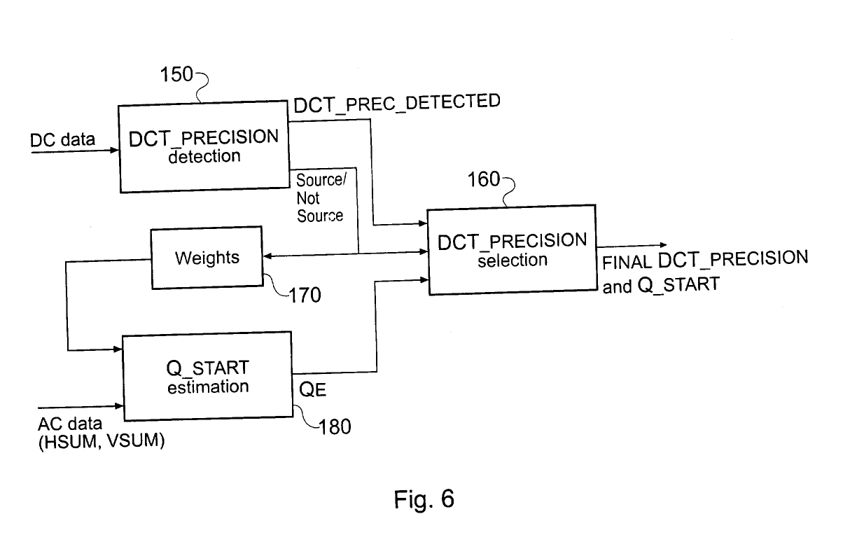

FIG. 6 schematically illustrates a parameter estimation circuit according to an embodiment of the invention. This parameter estimation circuit is implemented in the shuffle module 100 of the encoder of FIGS. 2 and 3. The parameter estimation circuit comprises a DCT_PRECISION detection module 150, a DCT_PRECISION selection module 160, a weights module 170 and a Q_START estimation module 180.

The DCT_PRECISION index has four possible values 0, 1, 2, 3 and is specified on a frame by frame basis. The parameter DCT_SCALER=2^{DCT}^{_{—PRECISION}} is the quantisation divisor associated with DCT_PRECISION. During the encoding process it is important to select the most appropriate value for DCT_PRECISION which is set and fixed prior to performing the series of trial quantisations. Furthermore it is necessary to provide an estimate for Q_START which is an estimate of the ideal Q_SCALE for the field or frame at the chosen DCT_PRECISION and it is used to determine the quantisation divisors for the lowest resolution trial quantisations performed by the bit allocation module 400.

The parameter estimation circuit of FIG. 6 analyses the input image data to calculate estimates for the DCT_PRECISION and Q_START. This circuit also determines whether the video data is “source” data that has not previously undergone an encode/decode cycle or “not source” data that has undergone at least one previous encode/decode cycle. The value of DCT_PRECISION is determined field by field or frame by frame in this embodiment. However, in alternative embodiments, the value of DCT_PRECISION could be calculated for each Macro-Block or for groups of Macro-Blocks.

The DCT_PRECISION detection module 150 determines whether the input video data is source or non-source and, in the case of non-source data, it detects the DCT_PRECISION index that was used in a previous encode/decode cycle. It outputs the value DCT_PREC_DETECTED which is supplied as input to the DCT_PRECISION selection module 160 and further outputs a “source”/“not source” decision on the input data which is passed on to the weights module 170 and the DCT_PRECISION selection module 160. The weights module 170 supplies weighting factors for the calculation performed by the Q_START estimation module 180. The weighting factors implemented by the weights module 170 depend on whether the video data has been classified as “source” or “not source”.

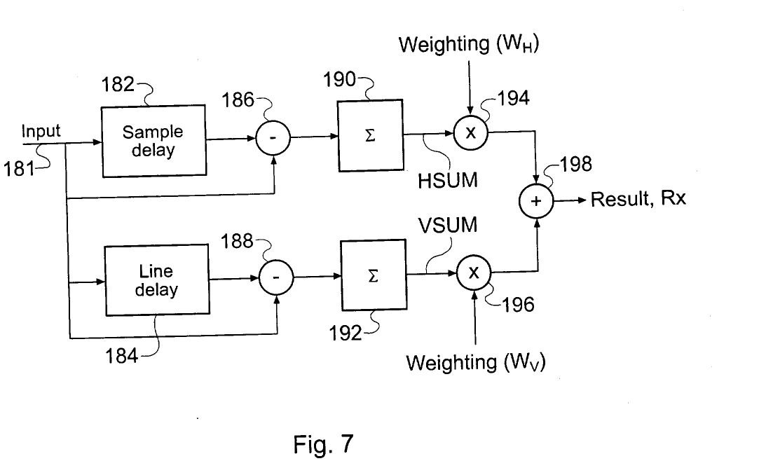

The Q_START estimation module 180 calculates an estimated Q_SCALE value Q_{E} for each frame/field. Q_{E} is the estimated ideal Q_SCALE for DCT_PRECISION=0 (corresponding to the least harsh quantisation). FIG. 7 schematically illustrates a portion of the Q_START estimation module of FIG. 6. FIG. 7 shows the processing performed on a single video component “X”. The results for each channel, of which there are three for RGB mode processing, but two for YC mode processing, are combined to produce the value Q_{E} for each frame/field. In FIG. 7 an input signal 181 for a single video component is supplied both directly and via a sample delay module 182 to a subtractor 186. The subtractor calculates differences between horizontally adjacent pixels and supplies the results to a summing module 190 which calculates the sum of horizontal pixel differences HSUM for the signal component of the input frame/field. The input signal 181 is also supplied to a further subtractor 188, both directly and via a line delay module 184. The subtractor 188 calculates differences between vertically adjacent pixels and supplies the results to a further summing module 192 which calculates the sum of vertical pixel differences VSUM for the signal component of the input frame/field.

The horizontal and vertical pixel differences across Macro-Block boundaries are excluded from HSUM and VSUM. Since the data is quantised Macro-Block by Macro-Block, different Macro-Blocks will typically have different quantisation parameters therefore pixel differences across Macro-Block boundaries are irrelevant in estimating how easily the data can be compressed. By excluding pixel differences across Macro-Block boundaries the accuracy of the estimate Q_{E} can be improved. Pixel differences across DCT block boundaries are also excluded from HSUM and VSUM. DCT is performed DCT block by DCT block so the difference between two DCT blocks is never actually encoded. The output HSUM of the summing module 190 is supplied to a multiplier 194 where it is multiplied by a horizontal weighting factor W_{H}. The output VSUM of the summing module 190 is supplied to a multiplier 194 where it is multiplied by a vertical weighting factor W_{V}.

The weighting factors W_{H} and W_{V} are supplied to the Q_START estimation module by the weights module 170. In this embodiment of the invention the respective values of W_{H} and W_{V} are different for “source data” and for “not source” data. However, in alternative embodiments W_{H} and W_{V} are set to the same respective values for “source data” and for “not source” data but the calculated value of Q_{E} is scaled by a scaling factor dependent on whether or not the image data is source data.

The weighting factors W_{H} and W_{V} are selected by performing tests on training images during which the value of Q_START is compared with the “ideal Q” which is the flat quantiser required to compress the image to the required bit rate. The weighting factors W_{H} and W_{V} are selected such that the discrepancy between Q_START and the ideal Q is reduced. Different values of the weighting factors (W_{H}, W_{V}) are used for each video signal component.

Returning to the circuit of FIG. 7, an adder 198 calculates the value R_{X} for each video component X according to the following formula:

R_{X}=W_{H}×HSUM+W_{V}×VSUM

where X is one of the signal components R, G, B, Y or C. The quantisation divisor estimate Q_{E} for each field/frame is given by the sum Q_{E}=R_{R}+R_{G}+R_{B} in RGB mode processing or by the sum Q_{E}=R_{Y}+R_{C} in YC mode processing.

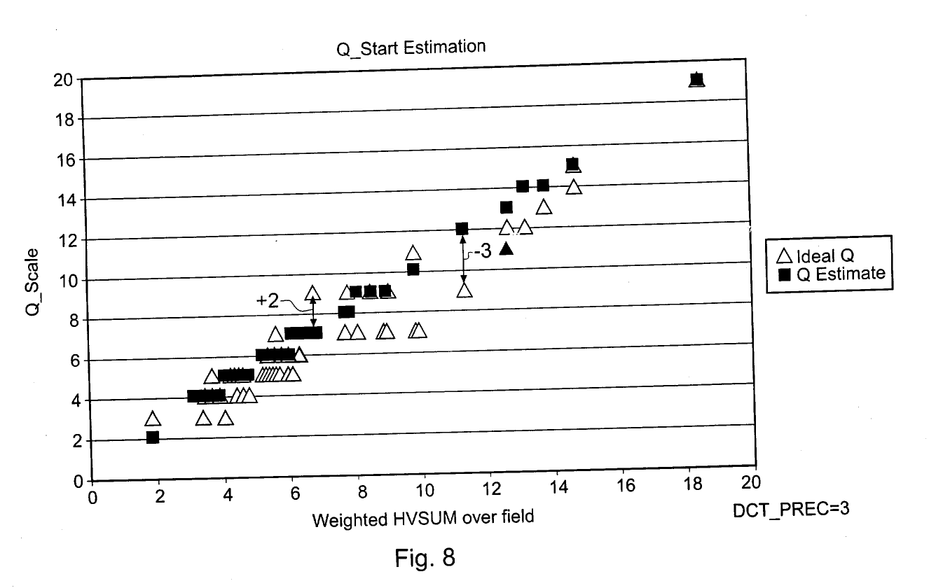

FIG. 8 is an example graph of Q_SCALE versus the weighted horizontal and vertical sum R_{X} for DCT_PRECISION=3. This figure illustrates the discrepancy between the ideal Q and Q_{E}. Such discrepancies are used to provide an error estimate for both Q_{E} and Q_START which is calculated from Q_{E}. Table 1 below gives an indication of the errors in Q_{E} and Q_SCALE for each value of DCT_PRECISION. These errors were estimated using the graph of FIG. 8. It can be seen from FIG. 8 that the minimum/maximum error on Q_SCALE is −3/+2. Thus an error of −3/+3 is allowed for at DCT_PRECISION=3 in Table 1. The errors for the other values of DCT_PRECISION scale accordingly, as shown in the table.

TABLE 1

| | MIN | MAX | MIN | MAX |
|---|---|---|---|---|
| DCT_{—} | error on | error On | error on | error on |
| PRECISION | Q_{E} | Q_{E} | Q_SCALE | Q_SCALE |
| 0 (least harsh) | −24 | +24 | −24 | +24 |
| 1 | −24 | +24 | −12 | +12 |
| 2 | −24 | +24 | −6 | +6 |
| 3 (most harsh) | −24 | +24 | −3 | +3 |

The Q_START estimation module 180 supplies the DCT_PRECISION selection circuit 160 with a signal specifying the value of Q_{E} for each frame/field.

The DCT_PRECISION selection circuit 160 determines a value Q_START for each field or frame in dependence upon Q_{E}. A value of the DCT_PRECISION index is estimated from the numerical value of Q_{E} as shown in table 2 below. Recall that the quantisation Q(AC) of the AC coefficients involves division by the product of factors Q_SCALE*NORM_ACT*DCT_SCALER where DCT SCALER=2^{DCT}^{_{—PRECISION}}. It follows that for “activity off” (NORM_ACT=1) the Q_SCALE value Q_START is given by Q_{E}/DCT_SCALER. However, even with “activity on” NORM_ACT should average to 1 across a field/frame so that it should have no effect on the accuracy of the Q_START estimate. Table 3 below shows the corresponding relationship between Q_{E} and Q_START for “activity on”. In this case the factor NORM_ACT lies is in the range 0.5 to 2.0 and must be taken into account to avoid selection of Q_START values outside the allowable range of Q_SCALE. Q_{E} is an estimate for Q_SCALE*DCT_SCALER from the denominator of Q(AC) so that Q_START corresponds to Q_SCALE.

TABLE 2
DCT_PRECISION Selection (Activity Off)

| Estimated | Q_SCALE_{—} | | |
|---|---|---|---|
| Quantiser, Q_{E} | TYPE | DCT_PRECISION | Q_START |
| Q_{E} < = 38 | Linear | 0 | Q_{E} |
| 38 < Q_{E} < = 100 | Linear | 1 | Q_{E}/2 |
| 100 < Q_{E} < = 224 | Linear | 2 | Q_{E}/4 |
| 224 < Q_{E} < = 464 | Linear | 3 | Q_{E}/8 |
| 464 < Q_{E} | non-linear | 3 | Q_{E}/8 |

TABLE 3
DCT_PRECISION Selection (Activity On: 0.5-2)

| Estimated | Q_SCALE_{—} | | |
|---|---|---|---|
| Quantiser, Q_{E} | TYPE | DCT_PRECISION | Q_START |
| Q_{E} < = 36 | Linear | 1 | Q_{E}/2 |
| 36 < Q_{E} < = 96 | Linear | 2 | Q_{E}/4 |
| 96 < Q_{E} < = 208 | Linear | 3 | Q_{E}/8 |
| 208 < Q_{E} Q_{E} | non-linear | 3 | Q_{E}/8 |

The Q_SCALE_TYPE in the second column of Table 2 and Table 3 specifies whether the values associated with the 31 available Q_SCALE_CODES represent a linear sequence or a non-linear sequence. As shown in the table of FIG. 3, the non-linear sequence extends to quantisation divisors of larger magnitude than those of the linear sequence.

The reasoning used to determine the appropriate range of Q_{E} corresponding to each value of DCT_PRECISION in Table 2 and in Table 3 will now be described in detail.

First consider Table 2 which corresponds to “activity off” mode. Using the linear Q_SCALE_TYPE of the table in FIG. 3, it can be seen that the maximum Q_SCALE available is 62.

At DCT_PRECISION=0 there is an estimated error of ±24 on Q_START. Therefore, to allow for this possible error, DCT_PRECISION=0 is not chosen unless Q_START≦38 (=62−24). This means that if the error on Q_START really is −24 and the real Q_SCALE required is 62 then this can still be achieved at the chosen DCT_PRECISION (0). Since at DCT_PRECISION=0, Q_START=Q_{E}, the value DCT_PRECISION=0 is chosen if QE≦38.

At DCT_PRECISION=1, there is an estimated error of −12 on Q_START. Therefore, to allow for this possible error, DCT_PRECISION=1 should not be chosen unless Q_START≦50 (=62−12). Since at DCT_PRECISION=1, Q_{—START=Q}_{E}/2, it follows that the value DCT_PRECISION=1 is chosen if Q_{E}≦100 (50*2).

At DCT_PRECISION=2 there is an estimated error of ±6 on Q_START. Therefore, to allow for this possible error, DCT_PRECISION=2 should not be chosen unless Q_START≦56 (=62−6). Since at DCT_PRECISION=2, Q_START=Q_{E}/4, it follows that the value DCT_PRECISION=2 is chosen if Q_{E}≦224 (56*4).

At DCT_PRECISION=3 there is an estimated error of ±3 on Q_START. Therefore, to allow for this possible error, DCT_PRECISION=3 should not be chosen unless Q_START≦58 (=62−3, rounded down to nearest.

Q_SCALE allowed). Since at DCT_PRECISION=3, Q_START=Q_{E}/8, it follows that the value DCT_PRECISION=3 is chosen if Q_{E}≦464 (58*8).

Otherwise the non-linear Q_SCALE_TYPE must be chosen at DCT_PRECISION=3 to allow more harsh quantisation.

Now consider Table 3 which corresponds to “activity on” mode. As for Table 2, referring to the linear Q_SCALE_TYPE of the table in FIG. 3, it can be seen that the maximum Q_SCALE available is 62. For “activity on” this is actually the maximum value for the product Q_SCALE*NORM_ACT, since this value is turned into a Q_SCALE_CODE before being applied.

NORM-ACT has a range of ×0.5 to ×2 which must be taken account of for activity on. Therefore, to allow for the possible ×2 effect of NORM_ACT the maximum value of Q_SCALE is taken to be 30, (note from FIG. 3 that a Q_SCALE of 31 is not allowed).

At DCT_PRECISION=0 there is an estimated error of ±24 on Q_START. Therefore, to allow for this possible error, DCT_PRECISION=0 should not be chosen unless Q_START≦6 (=30−24). However, 6 is below the minimum allowable Q_SCALE of 8 at DCT_PRECISION=0. It follows that the value DCT_PRECISION=0 cannot be chosen with activity on.

At DCT_PRECISION=1 there is an estimated error of ±12 on Q_START. Therefore, to allow for this possible error, DCT_PRECISION=1 should not be chosen unless Q_START>18 (=30−12). Since at DCT_PRECISION=1, Q_START=Q_{E}/2, it follows that the value DCT_PRECISION=1 is chosen if Q_{E}≦36 (18*2).

At DCT_PRECISION=2, there is an estimated error of ±6 on Q_START. Therefore, to allow for this possible error, DCT_PRECISION=2 should not be chosen unless Q_START≦24 (=30−6). Since at DCT_PRECISION=2, Q_START=Q_{E}/4, it follows that the value DCT_PRECISION=2 is chosen if Q_{E}≦96 (24*4).

At DCT_PRECISION=3, there is an estimated error of ±3 on Q_START. Therefore, to allow for this possible error, DCT_PRECISION=3 should not be chosen unless Q_START≦26 (=30−3, rounded down to nearest Q_SCALE allowed). Since at DCT_PRECISION=3, Q_START=Q_{E}/8, it follows that the value DCT_PRECISION=3 is chosen if Q_{E}≦208 (26*8).

Otherwise, the non-linear Q_SCALE_TYPE must be chosen at DCT_PRECISION=3 to allow harsher quantisation.

For input images categorised as “not source” the parameter estimation circuit calculates two separate estimates for the estimated value of DCT_PRECISION corresponding to a previous encode/decode cycle. The first estimate for DCT_PRECISION corresponds to the value DCT_PREC_DETECTED as calculated by the DCT_PRECISION detection module 150. The second estimate for DCT_PRECISION is obtained from the parameter Q_{E} that was calculated from sums of horizontal and vertical pixel differences HSUM and VSUM. We shall refer to this second estimate as DCT_PREC_Q_{E.} The values DCT_PREC_Q_{E} and DCT_PREC_DETECTED may indicate different decisions for the most appropriate value of DCT_PRECISION. If the two estimated values are not in agreement then a logical decision must be made to determine the final DCT_PRECISION value.

It is considered that when the value of Q_{E} used to determine DCT_PREC_Q_{E} is “close” to a boundary of one of the Q_{E} ranges as defined in the first column of Table 1 (for activity off) or Table 2 (for activity on) then DCT_PREC_DETECTED is considered to be more reliable than DCT_PREC_Q_{E}. In determining whether or not Q_{E} is close to the boundary account is taken of the likely errors in the Q_SCALE estimate Q_{E}.

Q_{E} is determined for each field/frame and is subject to two main types of variation. The variation in Q_{E} from frame to frame in an image sequence is termed “sequence jitter” whereas the variation in Q_{E} for a given image frame from one generation to the next is termed “generation jitter”. Image quality can be improved if the DCT_PRECISION values are stabilised such that jitter is reduced. In the present embodiment when determining the final DCT_PRECISION from DCT_PREC_DETECTED and DCT_PREC_Q_{E}, allowance is made for generation jitter. Note that although DCT_PREC_DETECTED is taken into account, it may still be necessary to select a different DCT_PRECISION from one generation to the next in circumstances where the required bit rates of the previous and current encoding differ considerably. In general, the required bit rates corresponding to previous encode/decode cycles will not be available during the current encoding process.

The final values of DCT_PRECISION and Q_START are determined for non-source images in dependence upon a comparison between DCT_PREC_DETECTED and DCT_PREC_Q_{E.} The comparison takes into account empirically determined values of maximum possible positive jitter J₊^{max} and minimum possible negative jitter J₋^{max}, which for this embodiment, are both set equal to 5.

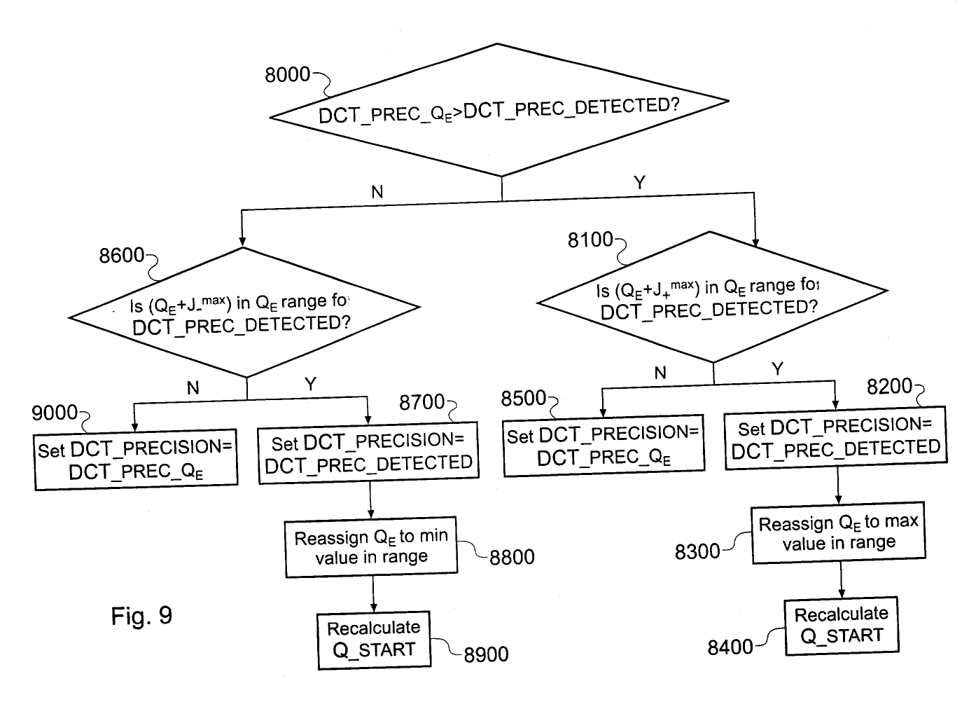

FIG. 9 is a flow chart illustrating how the final values of DCT_PRECISION and Q_START are selected. First consider the effects of positive jitter. If DCT_PREC_Q_{E}>DCT_PREC_DETECTED at step 8000 we proceed to step 8100 and if the value of Q_{E} minus J₊^{max} lies in the Q_{E} range corresponding to DCT_PRECISION=DCT_PREC_DETECTED in the third column of Table 1 or Table 2 above, then we proceed to step 8200 where the final value of DCT_PRECISION is set equal to DCT_PREC_DETECTED. Next, at step 8300 the value of Q_{E} is reassigned such that it corresponds to the maximum possible value within the Q_{E} range (from Table 1 or 2) associated with DCT_PREC_DETECTED. Effectively the final value of Q_{E} is shifted such that it falls within the Q_{E} range corresponding to the final DCT_PRECISION. This shift is in accordance with the predicted error in the value of the initially determined value of Q_{E}. After reassigning Q_{E} at step 8300 we proceed to step 8400 where the value of Q_START is recalculated in accordance with the fourth column of Table 1 or 2 so that it is appropriate to the reassigned value of Q_{E}.

If on the other hand at step 8100 the value of Q_{E} minus J₊^{max} lies outside the Q_{E} range corresponding to DCT_PRECISION=DCT_PREC_DETECTED in the third column of Table 2 or Table 3 above, we proceed to step 8500 where the final value of DCT_PRECISION is set equal to DCT_PREC_Q_{E}. The value of Q_START is not reassigned in this case.

Next consider the effects of negative jitter. If at step 8000 DCT_PREC_Q_{E}<DCT_PREC_DETECTED we proceed to step 8600 and if the value of Q_{E} plus J₋^{max} lies in the Q_{E} range corresponding to DCT_PRECISION=DCT_PREC_DETECTED in the third column of Table 2 or Table 3 above, then we further proceed to step 8700 where the final value of DCT_PRECISION is set equal to DCT_PREC_DETECTED. From step 8700 we proceed to step 8800 where the value of Q_{E} is reassigned such that it corresponds to the minimum possible value within the Q_{E} range (from Table 2 or 3) associated with DCT_PREC_DETECTED. Effectively the final value of Q_{E} is shifted such that it falls within the Q_{E} range corresponding to the final DCT_PRECISION. This shift is in accordance with the predicted error in the initially determined value of Q_{E}. After reassigning Q_{E} at step 8800 we proceed to step 8900 where value of Q_START is recalculated from the fourth column of Table 2 or 3, from the reassigned value of Q_{E}. If on the other hand, at step 8600 the value of Q_{E} plus J₋^{max} lies outside the Q_{E} range corresponding to DCT_PRECISION=DCT_PREC_DETECTED in the third column of Table 2 or Table 3 above, then we proceed to step 9000 where the final value of DCT_PRECISION is set equal to DCT_PREC_Q_{E}. In this case the value of Q_START is not reassigned.

The DCT_PRECISION selection module 160 in FIG. 5 outputs the final values of DCT_PRECISION and Q_START to the bit allocation module 400 of FIG. 2.

The DCT_PRECISION selection module 160 of the parameter estimation circuit of FIG. 6 also performs scene change detection. To determine whether or not a scene change has occurred the current values of Q_{E} and DCT_PRECISION are compared to the corresponding values for the previous field or frame. In order to perform the comparison the previous field or frame's Q_START value is converted back to a Q_{E} value according to the following algorithm:

If DCT_precision=0, Q_{E}=Q_START

Else if DCT_PRECISION=1, QE=Q_START*2

Else if DCT_PRECISION=2, QE=Q_START*4

Else if DCT_PRECISION=3, QE=Q_START*8

The final QE value assigned to the current field/frame is then compared to the QE of the previous field/frame as follows:

If |current QE−previous QE|>thsc then SCENE CHANGE detected

Else NO SCENE CHANGE detected

where th_{sc} is a predetermined scene change threshold. The scene change detection result is supplied as input to the bit allocation module 400 where it is used to determine how the activity value NORM_ACT is normalised.

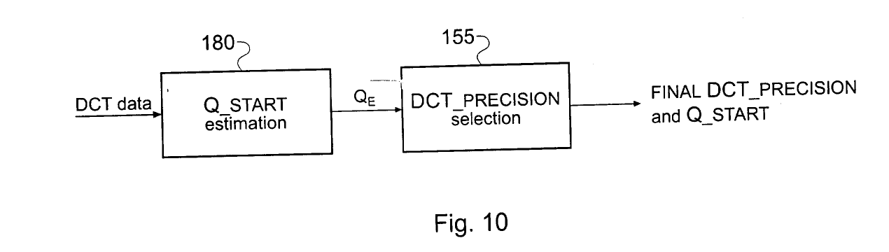

FIG. 10 schematically illustrates an alternative embodiment of the parameter estimation circuit of FIG. 6. This alternative embodiment comprises the Q_START estimation module 180 and the DCT_PRECISION selection module 155. It does not comprise a DCT_PRECISION detection module but simply selects an appropriate value of DCT_PRECISION from the Q_SCALE parameter Q_{E}.

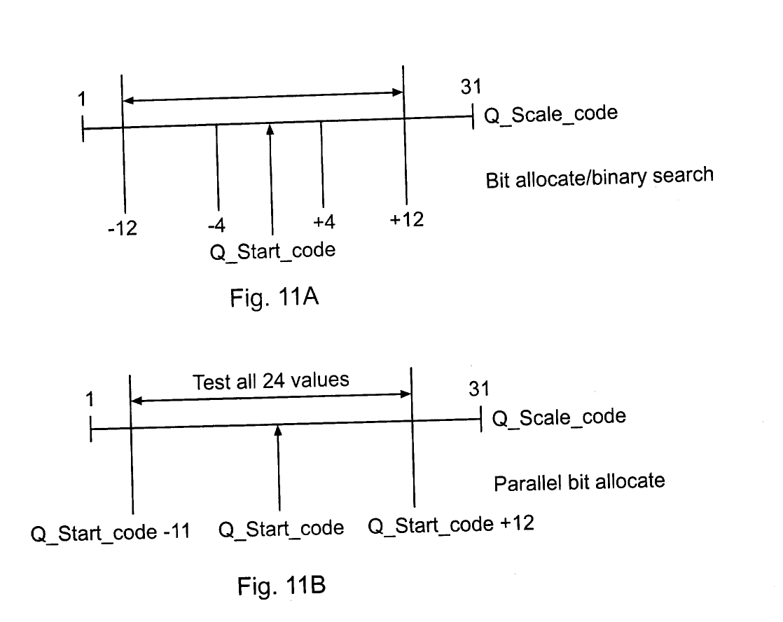

FIG. 11A schematically illustrates how the Q_START value calculated by the parameter estimation circuit of FIG. 6 is used to determine the trial quantisation divisors used by the binary search bit allocation module 400. The Q_SCALE_CODE≡Q_START_CODE corresponding to Q_SCALE=Q_START defines the centre of the range of Q_SCALE_CODE values tested during the trial quantisations. In particular the four Q_SCALE_CODE values tested are {Q_START_CODE-12, Q_START_CODE_{—}4, Q_START_CODE+4, Q_START_CODE+12}.

FIG. 11B schematically illustrates how the Q_START value calculated by the parameter estimation circuit of FIG. 6 is used to determine the trial quantisation divisors used by the parallel Q allocation module 1400 of FIG. 4. The Q_SCALE_CODE≡Q_START_CODE corresponding to Q_SCALE=Q_START defines the centre of the Q_SCALE_CODE values tested and all 24 Q_SCALE_CODE values from Q_START_CODE-11 up to Q_START_CODE+12 are tested in this case. Note that a full scan of the available Q_SCALE_CODES would involve 31 trial quantisations but the parameter Q_START has allowed us to reduce this to 24 trial quantisations.

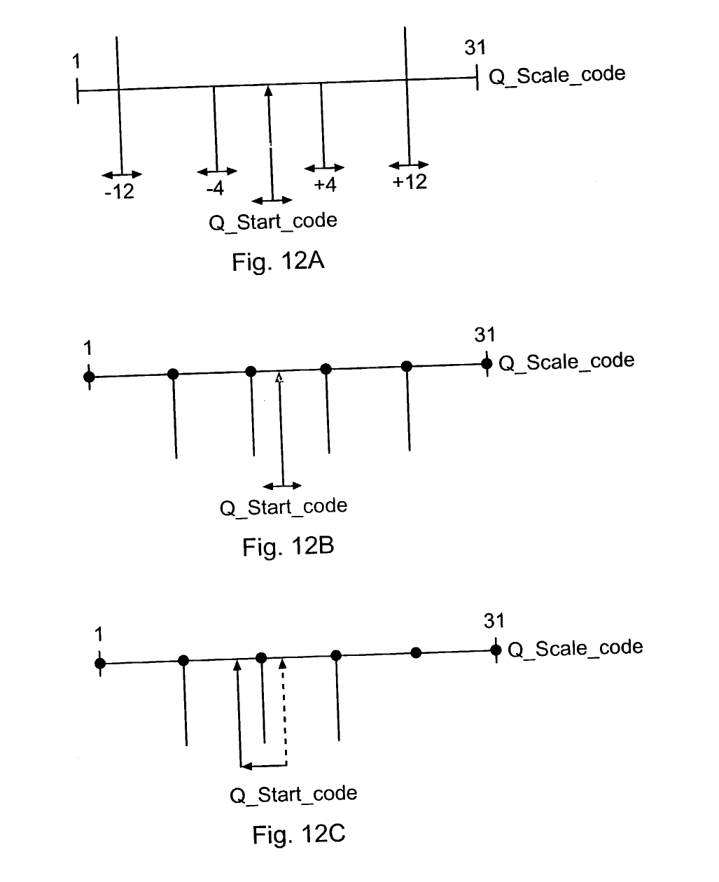

FIG. 12 schematically illustrates how Q_START is used to define the Q_SCALE_CODES for the bit allocation process in the case where a predetermined set of Q_SCALE_CODES is used. FIG. 12A illustrates the situation where Q_START_CODE defines the centre of the range of selected Q_SCALE_CODEs. In this case a change in the value of Q_START_CODE would result in a change in all 4 selected Q_SCALE_CODEs. FIG. 12B shows that Q_START_CODE is used to determine which set of a range of fixed and equally spaced Q_SCALE_CODEs are selected for bit allocation. In this case 4 Q_SCALE_CODEs are selected so that the central two Q_SCALE_CODEs straddle the Q_START_CODE. FIG. 12C illustrates that when Q_START_CODE shifts in value e.g. from one generation to the next or one image frame to the next, then 3 of the 4 selected Q_SCALE_CODEs remain the same as those selected in FIG. 12B.

We claim

1. A data compression apparatus operable to perform at least one trial quantisation in order to compress input data in accordance with said predetermined target output data quantity, said apparatus comprising:
(i) a quantisation starting point estimator to detect, from a property of said input data, a quantisation starting point representing an approximate value for a quantisation parameter suitable for achieving said predetermined target output data quantity;
(ii) one or more trial quantisers, each testing a degree of quantisation of at least part of said input data, said degree of quantisation being defined by a respective trial quantisation parameter;
(iii) a parameter controller for assigning a value of said trial quantisation parameter to each of said trial quantisers in dependence upon said quantisation starting point; and
(iv) a parameter selector for selecting a final level of quantisation for use in compression of said input data in accordance with results of said testing performed by said one or more trial quantisers, to ensure that said target output data quantity is not exceeded.

2. Apparatus according to claim 1, in which said input data represents one or more images.

3. Apparatus according to claim 2, in which said quantisation starting point estimator is operable to determine said quantisation starting point from a weighted sum of pixel differences in said input data.

4. Apparatus according to claim 3, in which said quantisation starting point estimator is operable to calculate a weighted sum of differences comprising a horizontal sum formed from at least one difference between horizontally adjacent pixel values and a vertical sum formed from at least one difference between vertically adjacent pixel values, wherein said horizontal sum is performed using a horizontal weighting factor and said vertical sum is performed using a vertical weighting factor.

5. Apparatus according to claim 4, in which said horizontal and vertical weighting factors are different.

6. Apparatus according to claim 5, in which different horizontal and vertical weighting factors are used for different input image signal components.

7. Apparatus according to claim 4, comprising a source detection arrangement for detecting whether said input data has undergone a previous compression/decompression cycle.

8. Apparatus according to claim 7, wherein said at least one weighting factor depends on said detection of whether said input data has undergone a previous compression/decompression cycle.

9. Apparatus according to claim 2, in which said quantisation starting point estimator is operable to determine said quantisation starting point in dependence upon an activity measure of said image or a portion thereof.

10. Apparatus according to claim 3, in which said input image data is compressed as a plurality of image regions.

11. Apparatus according to claim 10, wherein said quantisation starting point estimator is operable to exclude from said weighted sum those pixel difference values representing a difference between pixels in different image regions.

12. Apparatus according to claim 2, comprising scene change detection means for detecting said scene change by comparing a difference between values of said quantisation starting point for consecutive images with a predetermined threshold.

13. A method of data compression in which at least one trial quantisation is performed in order to compress input data in accordance with a predetermined target output data quantity, said method comprising the steps of:
(i) detecting, from a property of said input data, a quantisation starting point representing an approximate value for a quantisation parameter suitable for achieving said predetermined target output data quantity;
(ii) testing one or more degrees of quantisation of at least part of said input data, said degrees of quantisation being defined by a respective trial quantisation parameter;
(iii) assigning a value of said trial quantisation parameters in dependence upon said quantisation starting point; and
(iv) selecting a final level of quantisation for use in compression of said input data in accordance with results of said testing performed by said one or more trial quantisers, to ensure that said target output data quantity is not exceeded.

14. Computer software having program code for carrying out a method according to claim 13.

15. A data providing medium by which computer software according to claim 14 is provided.

16. A medium according to claim 15, said medium being a transmission medium.

17. A medium according to claim 16, said medium being a storage medium.
